(19) United States
(12) Patent Application Publication
(10) Pub. No.: US 2026/0205895 A1
(43) Pub. Date: Jul. 16, 2026

(54) Methods, Devices, and Systems for Performing Cell Determination Based on UE Capability

(71) Applicant: ZTE CORPORATION, Shenzhen, Guangdong (CN)

(72) Inventors: Jing SHI, Shenzhen (CN); Xianghui HAN, Shenzhen (CN); Xingguang WEI, Shenzhen (CN); Shuaihua KOU, Shenzhen (CN)

(21) Appl. No.: 19/136,537

(22) PCT Filed: May 11, 2023
(86) PCT No.: PCT/CN2023/093696

§ 371 Date: Jun. 6, 2025

(51) Int. Cl. H04W 36/00; H04L 5/00

(52) U.S. Cl. CPC H04W 36/0058; H04L 5/0098; H04W 36/00692

(57) ABSTRACT

The present disclosure describes methods, system, and devices for performing cell determination based on user equipment (UE) capability. One method includes reporting, by a UE, at least one UE capability for determining a cell, wherein: the cell comprises one or more frequency resource units based on the at least one UE capability. Another method includes receiving, by a base station, a report comprising at least one UE capability for determining a cell, wherein: the cell comprises one or more frequency resource units based on the at least one UE capability.

### CROSS-REFERENCE TO RELATED APPLICATION(S)

This application is a national phase entry under 35 USC 371 of International Patent Application No. PCT/CN2023/093696 filed on May 11, 2023, and the entire content of the International Patent Application is incorporated into this application by reference.

### TECHNICAL FIELD

The present disclosure is directed generally to wireless communications. Particularly, the present disclosure relates to methods, devices, and systems for performing cell determination based on user equipment (UE) capability.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC). And Carrier Aggregation (CA) can be both used in 4G and 5G and further communication system.

In some implementations, some user equipment (UE) capabilities may be reported by a UE, regardless the UE capabilities are same or similar among several bands. Meanwhile, after the UE capabilities for each band reported, the UE may be configured to reflect the corresponding UE capabilities.

### SUMMARY

The present disclosure relates to methods, systems, and devices for wireless communication, and more specifically, for performing cell determination based on user equipment (UE) capability. The various embodiments in the present disclosure may include methods for reporting UE capability and/or determining a cell according to the reported UE capability.

In one embodiment, the present disclosure describes a method for wireless communication (e.g., a method for determining a cell according to a reported UE capability). The method includes reporting, by a user equipment (UE), at least one UE capability for determining a cell, wherein: the cell comprises one or more frequency resource units based on the at least one UE capability.

In another embodiment, the present disclosure describes another method for wireless communication (e.g., a method for determining a cell according to a reported UE capability). The method includes receiving, by a base station, a report comprising at least one UE capability for determining a cell, wherein: the cell comprises one or more frequency resource units based on the at least one UE capability.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system including one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a schematic diagram of an exemplary embodiment for wireless communication.

FIG. 5B shows a schematic diagram of another exemplary embodiment for wireless communication.

FIG. 6 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context. The present disclosure describes methods and devices for performing cell determination based on user equipment (UE) capability.

New generation (NG) mobile communication system is moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC). In some implementations, coverage enhancement may be a requirement for 4G, 5G, and/or future generation communication system.

In some wireless communication systems, UE capabilities report may be per UE, per band, per band combination (BC), per feature set (FS), or per feature set per component carrier (FSPC). In another words, UE capability parameters may have hierarchical structure, for example, in the table of UE capability parameter, “per level” indicates the level with respect to which the associated parameter is included. Per “UE” may indicate the associated parameter is signaled per UE. Per “Band” indicates it is signaled per band. Per “BC” may indicate it is signaled per band combination. Per “FS” may indicate it is signaled per feature set (or per band per band combination). Per “FSPC” may indicate it is signaled per feature set per component carrier (or per component carrier (CC) per band per band combination). In some implementations, per “FD” may indicate to refer the associated field description.

In some implementations, some UE capabilities per band may be reported for each band by a UE, regardless the UE capabilities per band are same or similar among several bands. Meanwhile, after the UE capabilities for each band are reported, a radio resource control (RRC) configuration for the UE may also be configured per cell or carrier to reflect the corresponding UE capabilities if any. There are some issues/problems with such implementations, for example, how to use the similar or same UE capabilities more efficient to improve the efficiency of wireless communication.

The present disclosure describes various embodiments for performing cell determination based on user equipment (UE) capability, addressing at least one of the issues/problems discussed in the present disclosure.

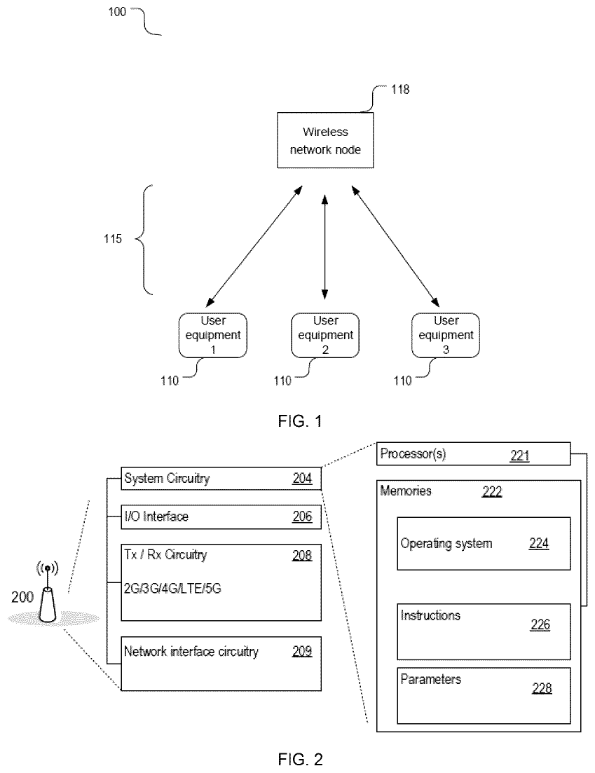

FIG. 1 shows a wireless communication system 100 including a wireless network node (or a wireless communication node, also referred to as a network base station) 118 and one or more user equipment (UE) (or a wireless communication device) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

FIG. 2 shows an example of electronic device 200 to implement a network base station. The example electronic device 200 may include radio transmitting/receiving circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

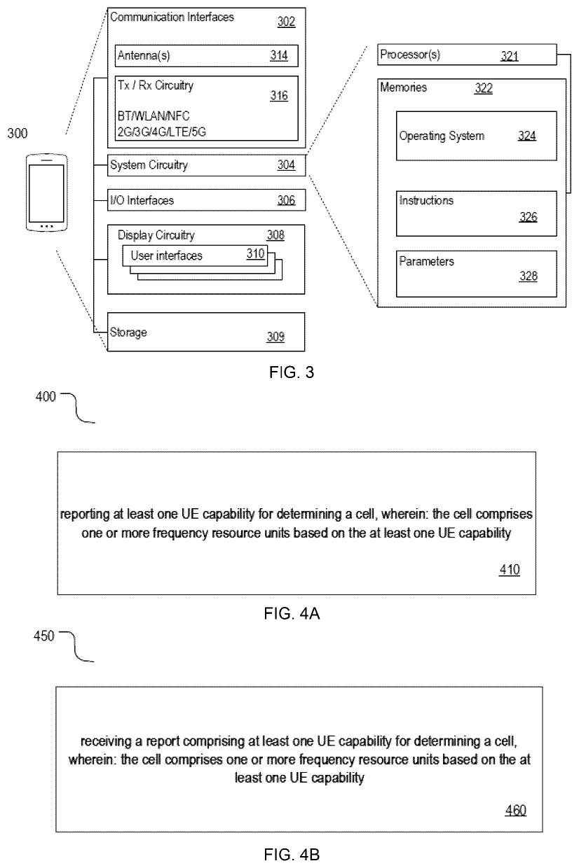

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry 308 may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit and receive circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G (the 2^{nd} generation mobile communication technology), 3G (the 3^{rd} generation mobile communication technology), BT (Blue Tooth), WiFi (wireless fidelity), Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiments for performing cell determination based on user equipment (UE) capability, which may be implemented, partly or totally, on the network base station and/or the user equipment described above in FIGS. 2-3. The various embodiments in the present disclosure may enable efficient wireless transmission in the telecommunication system, which may increase the resource utilization efficiency and/or boost performance of the wireless communication system.

In some implementations of a wireless communication system, among UE capability parameters, general parameters, service data adaptation protocol (SDAP) parameters, packet data convergence protocol (PDCP) parameters, radio link control (RLC) parameters, and medium access control (MAC) parameters may be reported only per UE. Physical layer parameters may have multiple report levels, and can be reported per UE, per BC, per band, per FS, and/or per FSPC.

In some implementations of a wireless communication system, for physical layer parameters, there are many parameters reported per band within BandCombinationList parameters and BandNR parameters. For non-limiting examples, some parameters are shown in Table 1 and Table 2.

TABLE 1
BandCombinationList parameters
Definitions for parameters

bandEUTRA
Defines supported EUTRA (Evolved Universal Terrestrial Radio Access) frequency band
by NR (New Radio) frequency band number.
bandNR
Defines supported NR frequency band by NR frequency band number.

TABLE 2
BandNR parameters
Definitions for parameters

additionalActiveTCI-StatePDCCH
Indicates whether the UE supports one additional active TCI-State for control in addition
to the supported number of active TCI-States for PDSCH. The UE can include this field
only if maxNumberActiveTCI-PerBWP is included in tci-StatePDSCH. Otherwise, the UE
does not include this field.
aperiodicBeamReport
Indicates whether the UE supports aperiodic ‘CRI/RSRP’ or ‘SSBRI/RSRP’ reporting on
PUSCH. The UE provides the capability for the band number for which the report is
provided (where the measurement is performed).
aperiodicTRS
Indicates whether the UE supports DCI triggering aperiodic TRS associated with periodic
TRS.
bandNR
Defines supported NR frequency band by NR frequency band number.

In various embodiments in the present disclosure, a cell may be referred as a soft cell or an aggregated cell, which may be defined and/or configured for a UE. In some implementations, a soft cell can be a UE-specific cell. The soft cell may be a cell comprising one or more frequency resource units (or referred as spectrum blocks), which may include legacy carriers, cells, or bands, based on one or more shared/same UE capabilities.

Referring to FIG. 4A, the present disclosure describes various embodiments of a method 400 for wireless communication. The method 400 may be performed by a wireless communication device (e.g., a user equipment). The method 400 may include step 410, reporting at least one UE capability for determining a cell, wherein: the cell comprises one or more frequency resource units based on the at least one UE capability.

Referring to FIG. 4B, the present disclosure describes various embodiments of a method 450 for wireless communication. The method 450 may be performed by a wireless communication node (e.g., a base station). The method 450 may include step 460, receiving a report comprising at least one UE capability for determining a cell, wherein: the cell comprises one or more frequency resource units based on the at least one UE capability.

In some implementations, the one or more frequency resource units comprise at least one of the following: a carrier, a cell, or a band.

In some implementations, the cell is determined by one of the following: multiple secondary cells (SCells) aggregation, multiple anchor cells aggregation, and/or multiple bands aggregation.

In some implementations, one frequency resource unit of the one or more frequency resource units is used to transmit paging; and/or other frequency resource units of the one or more frequency resource units are used to transmit data.

In some implementations, the at least one UE capability is reported according to one of the following: same for one or more frequency resource units; per set of frequency resource units; and/or supporting one cell comprising one or more frequency resource units.

In some implementations, the frequency resource unit is a band, a band set comprises one or more bands, and/or the at least one UE capability is reported per band set which is a granularity level between per band and per band combination (BC).

In some implementations, the UE reports a UE capability by one of the following: reporting a single value for the entire band set, reporting a value for each band in the band set, and/or reporting a reference value for the one band in the band set and an offset value for each other band in the band set.

In some implementations, the cell is based on serving cell level and comprises one or multiple bandwidth parts (BWPs), wherein a BWP comprises a band or multiple bands.

In some implementations, at least one radio resource control (RRC) parameter is configured by one of the following: comprising a single value per BWP with aggregated bandwidth of the band set, comprising a single value per BWP with contiguous frequency resource, and/or comprising a reference value for one BWP in the multiple BWPs and an offset value for each other BWP in the multiple BWPs.

In some implementations, in response to the cell scheduling, a frequency order of aggregated bandwidth is configured by one of the following: a higher-layer signaling, and/or a default frequency order.

In some implementations, the default frequency order comprises frequency locations with ascending order.

In some implementations, in response to the cell scheduling, the UE is scheduled with a retransmission on different BWPs with hybrid automatic repeat request (HARQ) entity shared among the multiple BWPs in the cell.

In some implementations, the cell is activated or deactivated on one of the following levels: a BWP or carrier level only, and/or a combination of a cell level and a BWP or carrier level.

In some implementations, the cell is activated based further on downlink (DL) or uplink (UL) frequency resource unit independently.

In some implementations, in response to transmitter (Tx) per band set being applied, a Tx switching is performed among a plurality of band sets regardless whether the plurality of band sets are within one cell.

In some implementations, the band sets are configured by one of the following: a higher-layer signaling, pre-defined, and/or switching period configuration of a band pair or a band group with zero microsecond forming a band set.

In some implementations, a band set comprises one or more BWPs on different bands, each of which comprises multiple BWPs, in one cell, and/or a band set comprises one or more carriers on different bands, each of which comprises multiple carriers, in one cell.

In some implementations, a switching period is reported based on one of the following: a band pair, or a band set pair.

### Embodiment Set I

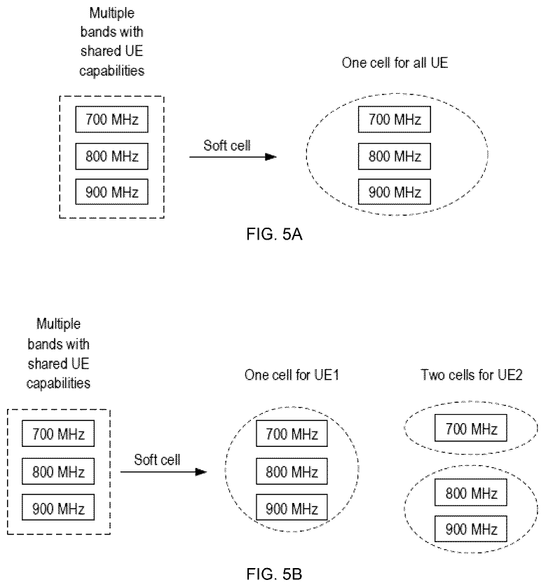

The present disclosure describes various embodiments for performing cell determination based on user equipment (UE) capability, wherein there may be two basic soft cell structures: one is cell-specific soft cell as shown in FIG. 5A, and the other is a UE-specific soft cell as shown in FIG. 5B.

The cell-specific soft cell may be defined or configured from the perspective of gNB. As shown in FIG. 5A, multiple bands are comprised in one cell, and for all UEs with support of the corresponding UE capability. In some implementations, the UE capability may be reported or mandatory by a UE supported by the cell comprising multiple bands.

The UE-specific soft cell may be defined or configured by gNB and based on UE capabilities. As shown in FIG. 5B, multiple bands are comprised in one cell, while for different UEs with support of the one or more corresponding UE capabilities, the number of multiple bands in one soft cell may be different based on UE capability report and/or gNB configuration for each UE. In some implementations, the UE capability may be reported or mandatory by a UE supported the cell comprising multiple bands.

In various embodiments/implementations, the terms of “soft cell” or “cell” may be used to refer to a UE-specific soft cell and/or a cell-specific soft cell. In some implementations, the soft cell may include a soft carrier which comprises the non-contiguous frequency resource from multiple bands, optionally the non-contiguous frequency resource is comprised by one BWP or multiple BWPs. In some implementations, the soft carrier may be a DL carrier or a UL carrier or a carrier comprising both DL and UL resources. In some implementations, the soft cell may include a soft BWP which comprises the non-contiguous frequency resource from multiple bands. In some implementations, the soft BWP may be a DL BWP or a UL BWP or a BWP comprising both DL and UL resources.

In some implementations, the soft cell may be defined or configured by one of following manners. For one method, a soft cell is only defined/supported/configured for secondary cell (SCell) enhancement, wherein the soft cell is constructed by multiple SCells aggregation. For another method, a soft cell may be defined/supported/configured for primary cell (PCell) or one cell enhancement, wherein the soft cell is constructed by multiple anchor cells aggregation. For another method, a soft cell may be defined/supported/configured for one or more cells enhancement, wherein the soft cell is constructed by multiple bands aggregation.

In some implementations, initial access may be supported by the soft cell. One or more bands within the soft cell may be used for synchronization signal and PBCH block (SSB) or broadcast transmission. One or more bands may be used for physical random access channel (PRACH) or msg3 transmission. For a non-limiting example, one band within the soft cell may be used for SSB or broadcast transmission, and all bands within the soft cell may be used for PRACH or msg3 transmission. In some implementations, the PRACH may be transmitted on one or more bands at a time, wherein the UE transmits the PRACH based on its capability of soft cell with all or partial bands.

In some implementations, paging may be transmitted on a BWP/carrier/band different with the BWP/carrier/band used in RRC connected state. For a non-limiting example, for a UE in RRC connected state, the multiple bands within the soft cell which are used for DL/UL traffic transmission, while the carrier/band used for paging within the soft cell is different with any one of the multiple bands within the soft cell which are used for DL/UL traffic transmission. There are benefits associated with these implementations, for example, saving network energy or UE power, wherein the energy or power may be saved in case the UE in a state without traffic transmission.

In some implementations, for a cell-specific soft cell, it may be simpler for gNB management. For one soft cell, there may be no difference for different UE adding/releasing. While, it may be more challenge for UE implementation.

In some implementations, for a UE-specific soft cell, it may be more friendly for different UE with different capabilities. While, it may be more complex for gNB management. For a non-limiting example, for a same shared band set comprising multiple bands, a single cell scheduling may be used for a UE, while carrier/cell aggregation may be used for another UE.

Various embodiments described in the present disclosure may have the following benefits: limiting RRC configuration and reducing UE complexity based on shared UE capabilities, wherein a soft cell is a cell comprise one or more legacy carriers/cells/bands based on one or more shared/same UE capabilities; and the soft cell may be cell-specific or UE-specific cell which is derived by multiple SCells aggregation or multiple anchor cells aggregation.

### Embodiment Set II

The present disclosure describes various embodiments for performing cell determination based on user equipment (UE) capability, wherein, to support soft cell, the one or more shared/same UE capabilities may comprise at least one of following UE capabilities per band/FS/FSPC.

For non-limiting examples in some implementations, one or more UE capabilities per band may include similar/same multiple-input multiple-output (MIMO) capabilities, i.e., additionalActiveTCI-StatePDCCH, aperiodicBeamReport, and/or multipleTCI, and when same sub-carrier spacing (SCS) is 15 KHz, bwp-DiffNumerology, bwp-SameNumerology, as shown in Table 3.

TABLE 3
BandNR parameters
Definitions for parameters

additionalActiveTCI-StatePDCCH
Indicates whether the UE supports one additional active TCI-State for control in addition
to the supported number of active TCI-States for PDSCH. The UE can include this field
only if maxNumberActiveTCI-PerBWP is included in tci-StatePDSCH. Otherwise, the UE
does not include this field.
aperiodicBeamReport
Indicates whether the UE supports aperiodic ‘CRI/RSRP’ or ‘SSBRI/RSRP’ reporting on
PUSCH. The UE provides the capability for the band number for which the report is
provided (where the measurement is performed).
multipleTCI
Indicates whether UE supports more than one TCI state configuration per CORESET.
UE is only required to track one active TCI state per CORESET. UE is required to support
minimum between 64 and number of configured TCI states indicated by tci-StatePDSCH.
This field shall be set to 1.
bwp-DiffNumerology
Indicates whether the UE supports BWP adaptation up to 4 BWPs with the different
numerologies, via DCI and timer. For the UE capable of this feature, the bandwidth of a
UE-specific RRC configured DL BWP includes the bandwidth of the CORESET#0 (if
CORESET#0 is present) and SSB for PCell and PSCell (if configured). For SCell(s), the
bandwidth of the UE-specific RRC configured DL BWP includes SSB, if there is SSB on
SCell(s).
bwp-SameNumerology
Defines type A/B BWP adaptation (up to 2/4 BWPs) with the same numerology, via DCI
and timer. For the UE capable of this feature, the bandwidth of a UE-specific RRC
configured DL BWP includes the bandwidth of the CORESET#0 (if CORESET#0 is
present) and SSB for PCell and PSCell (if configured). For SCell(s), the bandwidth of the
UE-specific RRC configured DL BWP includes SSB, if there is SSB on SCell(s).

For non-limiting examples in some implementations, one or more UE capabilities per FS may include, for 700/800/900 MHz, additionalDMRS-DL-Alt, and/or for similar physical channel procedure, pdcch-MonitoringAnyOccasions, pdsch-ProcessingType2, as shown in Table 4.

TABLE 4
FeatureSetDownlink parameters.
Definitions for parameters

additionalDMRS-DL-Alt
Indicates whether the UE supports the alternative additional DMRS position for co-
existence with LTE CRS. It is applied to 15kHz SCS and one additional DMRS case only.
pdcch-MonitoringAnyOccasions
Defines the supported PDCCH search space monitoring occasions. withoutDCI-gap
indicates whether the UE supports PDCCH search space monitoring occasions in any
symbol of the slot for Type 1-PDCCH common search space configured by dedicated
RRC signaling, for a Type 3-PDCCH common search space, or for a UE-specific search
space with the capability of supporting at least 44, 36, 22, and 20 blind decodes in a slot
for 15 kHz, 30 kHz, 60kHz, and 120 kHz subcarrier spacing values respectively. withDCI-
gap indicates whether the UE supports PDCCH search space monitoring occasions in
any symbol of the slot with minimum time separation of two OFDM symbols for 15 kHz,
four OFDM symbols for 30 kHz, seven OFDM symbols for 60 kHz with NCP (Normal
Cyclic Prefix), and 14OFDM symbols for 120kHz between two consecutive transmissions
of PDCCH scrambled with C-RNTI, MCS-C-RNTI, or CS-RNTI for Type 1-PDCCH
common search space configured by dedicated RRC signaling, for a Type 3-PDCCH
common search space, or for a UE-specific search space, with the capability of
supporting at least 44, 36, 22, and 20 blind decodes in a slot for 15 kHz, 30 kHz, 60kHz,
and 120 kHz subcarrier spacing values respectively.
pdsch-ProcessingType2
Indicates whether the UE supports PDSCH processing capability 2. The UE supports it
only if all serving cells are self-scheduled and if all serving cells in one band on which
the network configured processingType2 uses the same subcarrier spacing. This
capability signaling comprises the following parameters for each sub-carrier spacing
supported by the UE.
- fallback indicates whether the UE supports PDSCH processing capability 2 when the
number of configured carriers is larger than numberOfCarriers for a reported value of
differentTB-PerSlot. If fallback = ‘sc’, UE supports capability 2 processing time on a
carrier with a lowest cell index among the configured carriers in the band where the value
is reported, if fallback = ‘cap1-only’, UE supports only capability 1, in the band where the
value is reported;
- differentTB-PerSlot indicates whether the UE supports processing type 2 for 1, 2, 4
and/or 7 unicast PDSCHs for different transport blocks per slot per CC; and if so, it
indicates up to which number of CA serving cells the UE supports that number of unicast
PDSCHs for different TBs. The UE shall include at least one of numberOfCarriers for 1,
2, 4 or 7 transport blocks per slot in this field if pdsch-ProcessingType2 is indicated.

For non-limiting examples in some implementations, one or more UE capabilities per FSPC may include, in response to similar/same MIMO/Modem/SCS capabilities, maxNumberMIMO-LayersPDSCH, supportedBandwidthDL, supportedModulationOrderDL, supportedSubCarrierSpacingDL, as shown in Table 5.

TABLE 5
FeatureSetDownlinkPerCC parameters
Definitions for parameters

maxNumberMIMO-LayersPDSCH
Defines the maximum number of spatial multiplexing layer(s) supported by the UE for DL
reception. For single CC standalone NR, it is mandatory with capability signaling to
support at least 4 MIMO layers in the bands where 4Rx is specified as mandatory for the
given UE and at least 2 MIMO layers in FR2. If absent, the UE doesn't support MIMO on
this carrier.
supportedBandwidthDL
Indicates maximum DL channel bandwidth supported for a given SCS that UE supports
within a single CC.
For FR1, all the bandwidths as pre-defined for each band shall be mandatory with a
single CC unless indicated optional. For FR2, the set of mandatory CBW is 50, 100, 200
MHz. When this field is included in a band combination with a single band entry and a
single CC entry (i.e. non-CA band combination), the UE shall indicate the maximum
channel bandwidth for the band according to a pre-defined condition.
NOTE: To determine whether the UE supports a channel bandwidth of 90 MHz, the
network may ignore this capability for and validate instead the channelBW-90mhz and
the supportedBandwidthCombinationSet. For serving cells with other channel
bandwidths the network validates the channelBWs-DL, the
supportedBandwidthCombinationSet and supportedBandwidthDL.
supportedModulationOrderDL
Indicates the maximum supported modulation order to be applied for downlink in the
carrier in the max data rate calculation as pre-defined. If included, the network may use
a modulation order on this serving cell which is higher than the value indicated in this
field as long as UE supports the modulation of higher value for downlink. If not included:
- for FR1, the network uses the modulation order signaled in pdsch-256QAM-FR1.
- for FR2, the network uses the modulation order signaled per band i.e. pdsch-
256QAM-FR2 if signaled. If not signaled in a given band, the network shall use the
modulation order 64QAM.
In all the cases, it shall be ensured that the data rate does not exceed the max data rate
(DataRate) and max data rate per CC (DataRateCC) according to pre-defined conditions
supportedSubCarrierSpacingDL
Defines the supported sub-carrier spacing for DL by the UE, as pre-defined, indicating
the UE supports simultaneous reception with same or different numerologies in CA.
Support of simultaneous reception with same numerology for intra-band NR CA including
both contiguous and non-contiguous is mandatory with capability in both FR1 and FR2.
Support of simultaneous reception with two different numerologies between FR1 band(s)
and FR2 band(s) in DL is mandatory with capability if UE supports inter-band NR CA
including both FR1 band(s) and FR2 band(s). Optional for other cases. Support of
simultaneous reception of with different numerologies in CA for other cases is optional.

In some implementations, in order to support the soft cell, one or more UE capabilities may be reported per band set, wherein per band set is a level in between per band and per BC. For example, a BC is reported for carrier aggregation (CA), wherein one or more bands sets for combining the soft cell. Or one or more UE capabilities are reported per BC for the soft cell.

In some implementations, there may be per UE parameter to report whether to support soft cell. In some implementations, there may be no difference for FR1 and FR2, or only for FR1. In some implementations, the UE may report the supported band set per UE or per BC, for example, a band set is reported by a subset of band list per UE or per BC.

In some implementations, a UE capability parameter may be reported by one of following alternative methods. For one method, a single value may be reported per band set. For another method, a single value may be reported for each band, which is similar to a legacy method. For another method, a single value and a plurality of deltas (or offset values) may be reported for a band set, wherein the single value serves as a reference value for one band in the band set, and each of the plurality of deltas serve as an offset value for each other band in the band set, or for each band within the band set.

For a non-limiting example, when a max number of active CG is up to 12 in a BWP of a cell and reported per band, for a soft cell, it may be reported as the following. For one method, a total max number of the soft cell (or the band set), e.g., 30, is reported for the band set. For another method, a same max number of each band of the soft cell, e.g., 10, is reported. For another method, a max number of one reference band of the soft cell with delta (e.g., −4, −2, 0, 2, or 4) for each of the rest band, e.g., 10 for the 1st band and 2, 4 for the 2nd and 3rd band within the band set, are reported.

Various embodiments described in the present disclosure may have the following benefits: limiting RRC configuration and reducing UE capability report, wherein a soft cell is a cell comprising one or more legacy carriers/cells/bands based on one or more shared/same UE capabilities; and the soft cell may be cell-specific or UE-specific cell which is derived by multiple SCells aggregation or multiple anchor cells aggregation.

### Embodiment Set III

The present disclosure describes various embodiments for performing cell determination based on user equipment (UE) capability, wherein, in order to support the soft cell, configuration for the soft cell may be based on serving cell level, wherein a bandwidth part (BWP) configuration may be one of the following options.

For one option (Option 1), one BWP is configured to comprise one band. In some implementations, up to one active BWP may be configured in the cell; or more than one active BWP may be configured in the cell, wherein each BWP could comprise one band.

For another option (Option 2), one BWP is configured to comprise multi-band. In some implementations, up to one active BWP may be configured in the cell, and the UE may support a capability of CA; or more than one active BWP can be configured in the cell, wherein multiple BWP can be overlapped.

In some implementations, there is only one aggregated DL and/or only one aggregated UL carrier in the soft cell. In some implementations, the aggregated DL or UL carrier may be a soft carrier which comprises the non-contiguous frequency resource from multiple bands, optionally by one BWP or multiple BWPs. In some implementations, the soft cell may comprise a soft carrier which comprises both DL and UL resources. In some implementations, the soft cell may include a soft BWP which comprises the non-contiguous frequency resource from multiple bands. In some implementations, the soft BWP may be a DL BWP or a UL BWP or a BWP comprising both DL and UL resources.

In some implementations, for the soft cell, the RRC parameter configuration may be one of following alternatives. For one alternative (Alt.1), the RRC parameter is configured with single value per BWP with the aggregated bandwidth of the band set. For another alternative (Alt.2), the RRC parameter is configured with single value per BWP with contiguous frequency resource. For another alternative (Alt.3), the RRC parameter is configured with single value for multiple BWPs or bands, and a delta or offset value for (the rest) each BWP or band within the band set. For example, based on Option 1, Alt.2 or Alt.3 may be applied; and/or based on Option 2, Alt.1 may be applied.

Taking an RRC parameter of the configured grant type 1 as a non-limiting example, frequencyDomainAllocation may be configured by one of following alternatives. Alt.1 BIT STRING (e.g., 30 bits) for the aggregated BWP of the band set may be configured. Alt.2 BIT STRING (e.g., 18 bits) per BWP may be configured; Alt.3 BIT STRING (e.g., 18 bits) for a reference BWP or band and additional bits that is delta value (e.g., 2 bits for (the rest) each BWP or band) to indicate allocation of the rest resource block groups (RBGs) may be configured.

Various embodiments described in the present disclosure may have the following benefits: limiting RRC configuration and reducing UE capability report, wherein a soft cell is a cell comprise one or more legacy carriers/cells/bands based on one or more shared/same UE capabilities; and the soft cell may be cell-specific or UE-specific cell which is derived by multiple SCells aggregation or multiple anchor cells aggregation.

### Embodiment Set IV

The present disclosure describes various embodiments for performing cell determination based on user equipment (UE) capability, wherein, for the operation on the soft cell, such as scheduling, (re)transmission, hybrid automatic repeat request-acknowledgement (HARQ-ACK) feedback, both single aggregated BWP and multiple BWP operation may be performed.

In some implementations, for scheduling, when based on single cell scheduling, a UE may be scheduled within the aggregated bandwidth of the band set, wherein a wide-band scheduling may be performed. RBG for each BWP and RBG for the aggregated bandwidth may be configured independently. The frequency order (including index of RB, RBG, BWP, etc.) of the aggregated bandwidth may be configured explicitly, or may be configured according to a default configuration that is derived by the frequency location with ascending order. When based on multi-cell scheduling, a UE may be scheduled within the band set (or soft cell) similar as the set of cells configured in multi-cell scheduling, while some type-2 fields (including independent indication fields) may be optimized by one of following options: Option 1, indicate a single value and applied for all BWP (or band); Option 2, indicate a single value and applied for a reference BWP (or band) and delta value for (the rest) each BWP (band); and/or Option 3, indicate one row of a joint-code RRC table for all BWPs (or bands).

In some implementations, for transmission or retransmission, when based on single cell scheduling, a UE may be scheduled within the aggregated bandwidth of the band set, wherein a wide-band scheduling may be performed. A single transport block (TB) may be generated per one soft cell (or band set), or a single TB with code block group (CBG) set with each CBG applied for each BWP (or band). When based on multi-cell scheduling, a UE may be scheduled within the band set (or soft cell) similar as the set of cells configured in multi-cell scheduling with different TB. In some implementations, the different TB may be generated on different BWP (or band). In some implementations, retransmission may be performed on different BWP (or band) with HARQ entity shared in the soft cell.

In some implementations, for HARQ-ACK feedback, when based on single cell scheduling, a UE may be scheduled within the aggregated bandwidth of the band set, wherein a wide-band scheduling may be performed. A TB or CBG level based codebook may be used for the transmission; or a BWP (or band) level HARQ-ACK feedback may be used, which may be derived by CBG group, e.g., one HARQ-ACK bit per CBG set which is corresponding to a BWP (or band). When based on Multi-cell scheduling, a UE may be scheduled within the band set (or soft cell) similar as the set of cells configured in multi-cell scheduling, which the HARQ-ACK bits for the cells are within a same PUCCH group. In some implementations, a TB level codebook may be used for each BWP (or band) within the soft cell (or band set).

In some implementations, for the operation of (de)activation of the soft cell, it may be performed only based on a BWP level or carrier level, or both cell level combined with a BWP level or carrier level, either of which may be further combined with DL and UL BWP/carrier/cell/band independently. Option 1, the soft cell may be always activated, and the BWP (or band) within the soft cell (or band set) may be activated/deactivated by signaling, e.g., downlink control information (DCI) or RRC or medium access control (MAC) control element (CE). In some implementations, one or more BWP (or band) may be added/released to/from the soft cell at a time. Option 2, the soft cell may be activated/deactivated, and activated soft cell may comprise one or more BWP (or band), which may optionally be also applied for the deactivated soft cell. In some implementations, the soft cell switching may be performed based on L1 or L2 or L3 signaling with independent band set of each soft cell. In some implementations, L1 or L2 or L3 signaling is further combined with DL BWP/carrier/cell/band and UL BWP/carrier/cell/band independently, to perform soft cell switching. For non-limiting examples, one cell with DL BWP #0/1/2/3 and UL BWP #0/1, only UL BWP #1 is deactivated when there is less UL traffic, or UL BWP #2 is activated when there are more UL traffic.

Various embodiments described in the present disclosure may have the following benefits: limiting RRC configuration and reducing UE capability report, wherein a soft cell is a cell comprise one or more legacy carriers/cells/bands based on one or more shared/same UE capabilities; and the soft cell may be cell-specific or UE-specific cell which is derived by multiple SCells aggregation or multiple anchor cells aggregation.

### Embodiment Set V

The present disclosure describes various embodiments for performing cell determination based on user equipment (UE) capability, wherein, an enhancement for band set operation is the UL Tx switching enhancement, which may be performed based on soft cell. In some implementations, BWP (or band) or carrier based UL Tx switching may be applied in the soft cell, and one or multiple carriers may share one Tx.

In some implementations, when Tx per band is still applied, the switching may be performed among multiple BWPs or carriers or bands regardless within one cell or not. Option 1: Switching based on BWP/carrier/band regardless of carrier type. UL Tx switching for one cell with multiple BWP/carrier/band may be operated as switching manner of carrier aggregation with a configuration of band combination. One non-limiting example includes a band combination for one cell and optionally for UL Tx switching, i.e. BandCombinationForOneCell-UplinkTxSwitch. Option 2: Switching based on BWP/carrier/band with some restrictions for one or more carriers within the cell. Alt.1: supplementary uplink (SUL) carrier may not support concurrent transmission with any other NUL carrier. In the case, all of the NUL carriers within the cell are corresponding NUL carrier defined/configured for the SUL. Alt.2: SUL carrier may not support concurrent transmission with one corresponding NUL carrier. In the case, one of the NUL carriers within the cell is the corresponding NUL carrier defined/configured for the SUL. Alt.3: Based on RRC configuration, whether SUL carrier and (non-)corresponding NUL carrier support concurrent transmission may be configurable. Alt.4: When more than one SUL carrier are included in the cell, besides Alt.3, whether SUL carrier and other SUL carrier supports concurrent transmission may be configurable.

In some implementations, when Tx per band set is applied, the switching may be performed among band sets regardless within one cell or not.

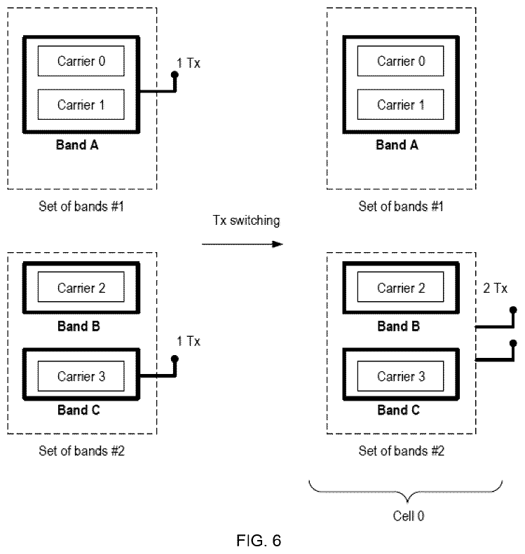

In some implementations, a set of bands (or a band set) may be derived by RRC configuration or predefined in the spec, or by 0 us switching period configuration. In some implementations, some restrictions comprise at least one of the following. Alt.1: One or more BWPs/carriers on different bands of the multiple BWPs/carriers in one cell may be grouped as a set of bands. As shown in FIG. 6, Tx per set of bands and the more BWPs/carriers may be used to UL transmission for a UE with up to 2Tx. In some implementations, multiple BWPs/carriers on different bands in one cell may be a set of bands, wherein Tx per cell comprises multiple bands. Alt.2: only the carriers on different bands within one cell may be configured to a set of bands, wherein normal cell may not support the set of bands. When the carriers of the bands within a cell are defined/configured/from a BC, set of bands may be only configured within a band combination (-UplinkTxSwitch). When the carriers of the bands within a cell are defined/configured/from more than one BC, set of bands may be from different BC. Alt.3: when at least one carrier is SUL carrier, a set of bands may only comprise same type of bands, wherein a set of bands with both NUL band and SUL band may not be permitted.

In some implementations, another scheme to derive a virtual band or set of bands may include configuring switching period being equal to 0 microsecond (us) for a band pair or band combination. For non-limiting example as shown in FIG. 6, switching period of band B & C, that is T_switch of from B to C (T_switchB-C), is configured as 0 us, and a band set or a virtual band comprising band B and Band C is generated.

In some implementations, for UL Tx switching, it may be performed based on the at least one BWP/carrier on a set of bands or virtual band, wherein Tx switching may be performed across different band sets. For a non-limiting example, for a UE indicating a capability for uplink switching with BandCombination-UplinkTxSwitch for a band combination, and when it is for that band combination configured in a serving cell with multiple uplink carriers with higher layer parameter uplinkConfigList and with each uplinkConfig associated a bandSetid: when the UE is configured with uplink switching with parameter uplinkTxSwitching, and when the UE is to transmit in the uplink based on DCI(s) received before T₀-T_{offset} or based on a higher layer configuration(s): when the UE is to transmit a 2-port transmission on one uplink carrier on one band set and when the preceding uplink transmission is a 1-port transmission on another uplink carrier on another band set, the UE may not be expected to transmit for the duration of N_{Tx1-Tx2} on any of the carriers.

In some implementations, for switching period, it may be reported based on a band pair or band set pair. When being based on band pair, the switching gap may be determined by the maximum switching period of the band pairs involved within the band of sets switching. For a non-limiting example as shown in FIG. 6, switching gap is determined by Max {T_switchA-B, T_switchA-C, T_switchB-C} or Max {T_switchA-B, T_switchA-C}; and in some implementations, T_switchB-C may be 0 us. In some implementations, switching period for any one of the bands in one set with another band may be same. When being based on band pair set, a set of bands is defined/configured, switching period of band set pair is reported or configured. For a non-limiting example, uplinkTxSwitchingPeriodofBandSet is introduced for the switching period of band set pair.

Various embodiments described in the present disclosure may have the following benefits: it is benefit for a UE to use the multiple fragmented and adjacent spectrum resources, wherein the multiple carriers are located with different bands and the number of Tx for the UE may be restricted up to 2; and with Tx per band set, it is benefit for the UE to utilize more BWPs/carriers/bands in one cell or multiple cells, wherein a soft cell is a cell comprise one or more legacy carriers/cells/bands based on one or more shared/same UE capabilities.

The present disclosure describes methods, apparatus, and computer-readable medium for wireless communication. The present disclosure addressed the issues with performing cell determination based on user equipment (UE) capability. The methods, devices, and computer-readable medium described in the present disclosure may facilitate the performance of wireless communication, thus improving efficiency and overall performance. The methods, devices, and computer-readable medium described in the present disclosure may improve the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method for wireless communication, comprising:
reporting, by a user equipment (UE), at least one UE capability for determining a cell, wherein:
the cell comprises one or more frequency resource units based on the at least one UE capability.

2. A method for wireless communication, comprising:
receiving, by a base station, a report comprising at least one user equipment (UE) capability for determining a cell, wherein:
the cell comprises one or more frequency resource units based on the at least one UE capability.

3. The method according to claim 1, wherein:
the one or more frequency resource units comprises at least one of the following: a carrier, a cell, or a band; or
one frequency resource unit of the one or more frequency resource units is used to transmit paging; and other frequency resource units of the one or more frequency resource units are used to transmit data.

4. The method according to claim 1, wherein, the cell is determined by one of the following:
multiple secondary cells (SCells) aggregation,
multiple anchor cells aggregation, or
multiple bands aggregation.

5. (canceled)

6. The method according to claim 1, wherein:
the at least one UE capability is reported according to one of the following:
same for one or more frequency resource units;
per set of frequency resource units; or
supporting one cell comprising one or more frequency resource units.

7. The method according to claim 6, wherein:
a frequency resource unit is a band,
a band set comprises one or more band, and
the at least one UE capability is reported per band set which is a granularity level between per band and per band combination (BC).

8. The method according to claim 7, wherein, the UE reports a UE capability by one of the following:
reporting a single value for the entire band set,
reporting a value for each band in the band set, or
reporting a reference value for one band in the band set and an offset value for each other band in the band set.

9. The method according to claim 1, wherein:
the cell is based on serving cell level and comprises one or multiple bandwidth part (BWP), wherein a BWP comprising a band or multiple bands.

10. The method according to claim 9, wherein, at least one radio resource control (RRC) parameter is configured by one of the following:
comprising a single value per BWP with aggregated bandwidth of a band set,
comprising a single value per BWP with contiguous frequency resource, or
comprising a reference value for one BWP in the multiple BWPs and an offset value for each other BWP in the multiple BWPs.

11. The method according to claim 1, wherein:
in response to the cell scheduling, a frequency order of aggregated bandwidth is configured by one of the following:
a higher-layer signaling, or
a default frequency order.

12. The method according to claim 11, wherein:
the default frequency order comprises frequency locations with ascending order.

13. The method according to claim 1, wherein:
in response to the cell scheduling, the UE is scheduled with a retransmission on different BWP with hybrid automatic repeat request (HARQ) entity shared among multiple BWPs in the cell.

14. The method according to claim 1, wherein, the cell is activated or deactivated on one of the following levels:
a BWP or carrier level only, or
a combination of a cell level and a BWP or carrier level.

15. The method according to claim 14, wherein:
the cell is activated based further on downlink (DL) or uplink (UL) frequency resource unit independently.

16. The method according to claim 1, wherein:
in response to transmitter (Tx) per band set being applied, a Tx switching is performed among a plurality of band sets regardless whether the plurality of band sets are within one cell.

17. The method according to claim 16, wherein, the band sets are configured by one of the following:
a higher-layer signaling,
pre-defined, or
switching period configuration of a band pair or a band group with zero microsecond forming a band set.

18. The method according to claim 16, wherein:
a band set comprises one or more BWPs on different bands, each of which comprises multiple BWPs, in one cell, or
a band set comprises one or more carriers on different bands, each of which comprises multiple carriers, in one cell; or
a switching period is reported based on one of the following: a band pair, or a band set pair.

19. (canceled)

20. A wireless communications apparatus comprising a processor and a memory, wherein the processor is configured to read code from the memory and execute the steps of:
reporting at least one UE capability for determining a cell, wherein:
the cell comprises one or more frequency resource units based on the at least one UE capability.

21. A computer program product comprising a computer-readable program medium code stored thereupon, the computer-readable program medium code, when executed by a processor, causing the processor to implement a method recited in claim 1.

22. The method according to claim 17, wherein:
a band set comprises one or more BWPs on different bands, each of which comprises multiple BWPs, in one cell, or a band set comprises one or more carriers on different bands, each of which comprises multiple carriers, in one cell; or
a switching period is reported based on one of the following: a band pair, or a band set pair.
